(19) United States
(12) Patent Application Publication
(10) Pub. No.: US 2016/0127792 A1
(43) Pub. Date: May 5, 2016

(54) ONLINE VIDEO PLAYING SYSTEM AND METHOD

(71) Applicant: FIH (HONG KONG) LIMITED, Kowloon (HK)

(72) Inventor: PEI-HSIN WU, New Taipei (TW)

(21) Appl. No.: 14/734,771

(22) Filed: Jun. 9, 2015

(30) Foreign Application Priority Data
Oct. 30, 2014 (TW) 103137544

(51) Int. Cl. H04N 21/482

(52) U.S. Cl. CPC H04N 21/4825; H04N 21/482

(57) ABSTRACT

An online video playing method is executed by at least one processor of a server. The server includes a storage device. The storage device stores videos and a database which stores information of the videos. The information corresponding to at least one video is retrieved. A video is added into a playlist according to the corresponding information. At least one video listed in the playlist is played.

### CROSS-REFERENCE TO RELATED APPLICATIONS

This application claims priority to Taiwan Patent Application No. 103137544 filed on Oct. 30, 2014, the contents of which are incorporated by reference herein.

### FIELD

The subject matter herein generally relates to recommending video technology, and particularly to an online video playing system and method.

### BACKGROUND

With the popularity of video sharing sites, there are many videos on the site. It can be a problem for a user to choose a video to view quickly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a server.

FIG. 2 is a block diagram of one embodiment of function modules of an online video playing system.

FIG. 3 illustrates a flowchart of one example embodiment of an online video playing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The present disclosure, including the accompanying drawings, is illustrated by way of examples and not by way of limitation. It should be noted that references to “an” or “one” embodiment in this disclosure are not necessarily to the same embodiment, and such references mean “at least one”.

The term “module”, as used herein, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

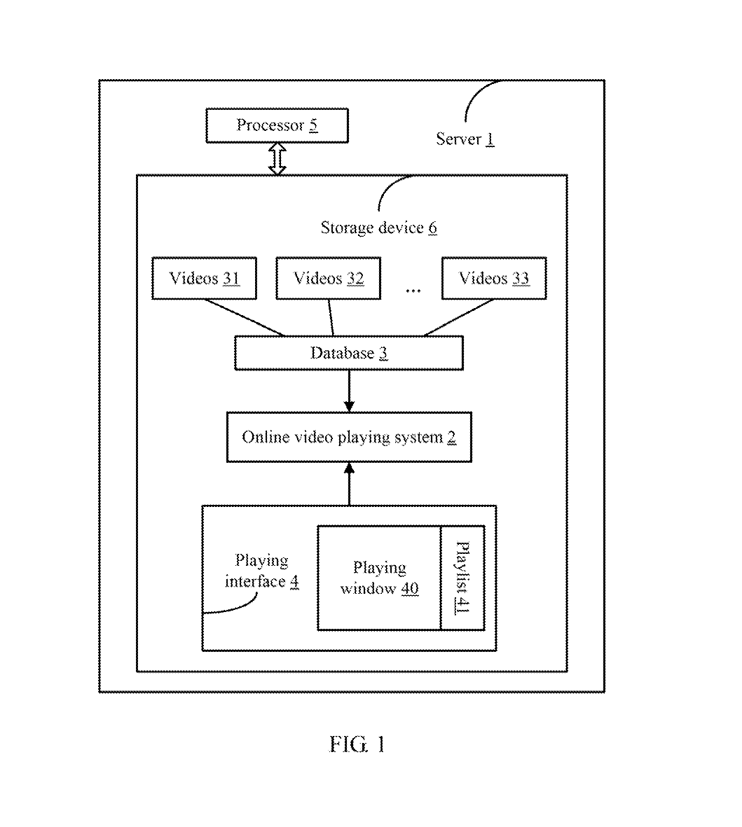

FIG. 1 is a block diagram of one embodiment of a server. The server 1 includes, but is not limited to, an online video playing system 2, a database 3, a play interface 4, at least one processor 5 and a storage device 6. The server 1 can be any server of a video/audio sharing site which can share audio/video.

The online video playing system 2 includes computerized codes, which when be executed, can be used to analyze popular videos from the server 1, add the popular videos into a playlist, and play at least one video listed in the playlist.

The database 3 can be used to store information of each video, such as a number of clicks in one day, a number of likes in one day, a total number of clicks, a total number of likes, an upload time, an upload address, a storage path, and so on.

The play interface 4 can be used to play video. The play interface 4 includes, but is not limited to, a playing window 40 and a playlist 41. The playing window 40 is used to play video frames. The playlist 41 include a video list which can be determined by the online video playing system 2.

In at least one embodiment, the at least one processor 5 can be a central processing unit (CPU), a microprocessor, or other data processor chip that performs functions of the server 1.

The storage device 6 can include various type(s) of non-transitory computer-readable storage medium. For example, the storage device 6 can be an internal storage system, such as a flash memory, a random access memory (RAM) for temporary storage of information, and/or a read-only memory (ROM) for permanent storage of information. The storage device 6 can also be an external storage system, such as a hard disk, a storage card, or a data storage medium. The storage device 6 can store videos according to different properties, such as types, upload addresses, performers, and so on. Referring to FIG. 1, the videos 31 are stored according to types, the videos 32 are stored according to upload address, and the videos 33 are stored according to performers.

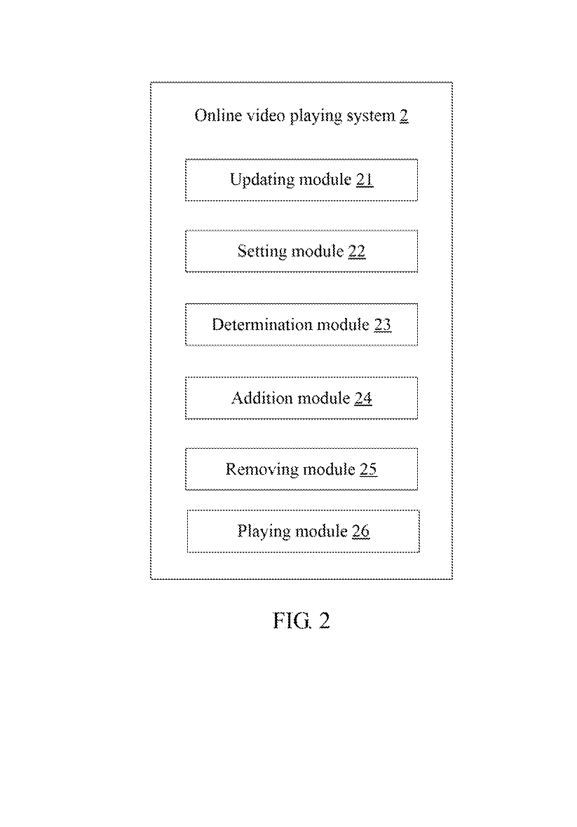

Referring to FIG. 2, a block diagram of one embodiment of function modules of the online video playing system. The online video playing system 2 can include an updating module 21, a setting module 22, a determination module 23, an adding module 24, a removing module 25 and a playing module 26. The function modules 21-26 can include computerized codes in the form of one or more programs, which are stored in the storage device 6. The at least one processor 5 executes the computerized codes to provide functions of the function modules 21-26.

The updating module 21 can retrieve information corresponding to each video stored in the storage device 6 of the server 1, and update the information into the database 3. In this embodiment, the updating module 21 retrieves information corresponding to each video at a predetermined time interval. The information corresponding to each video includes, but is not limited to, a path where the video is stored in the storage device 6, a total number of clicks, a total number of likes, a number of clicks in one day, a number of likes in one day, an upload time and an upload address of the video.

The setting module 22 can set a first preset value and a second preset value. The first preset value is a threshold of the total number of clicks/likes. The second preset value is a threshold of the number of clicks/likes in one day.

In some embodiments, the first preset value and the second can be set to a fix number. For example, the first preset is set to 100000. In other embodiments, the first preset value and the second preset value can be set dynamically. For example, the setting module 22 makes the videos stored in the storage device 6 in a sequence according to the total number of clicks/likes, and sets the first preset value as the total number of clicks/likes of the nth video, such as n=20.

The determination module 23 can determine whether the total number of clicks/likes of each video matches the first preset value and whether the number of clicks/likes in one day of each video matches the second preset value. In one embodiment, the determination module 23 can also determine whether a number of videos in the playlist 41 matches a third preset value.

The adding module 24 can add the video whose total number of clicks/likes matches the first preset value or whose number of clicks/likes in one day matches the second preset value, into the playlist 41. In some embodiments, the adding module 24 also can sequence the videos in the playlist 41 according to the upload time of the video. For example, the video whose upload time is the latest will be on the top/bottom of the playlist 41. In some other embodiments, the adding module 24 sequences the videos in the playlist 41 according to other properties, such as the total number of clicks/likes.

When the number of videos in the playlist 41 matches the third preset value, the removing module 25 can remove the video whose total number of clicks/likes is the lowest or whose number of clicks/likes in one day is the lowest, from the playlist 41.

The playing module 26 can play at least one video listed in the playlist. The server 1 can be connected by a client (such as a browser) through the Internet. The client can get the playing interface 4. In some embodiments, the playing module 26 automatically chooses a video from the playlist 41, and plays the chosen video in the playing window 40 of the playing interface 4. For example, the playing module 26 automatically chooses a video from the playlist 41 which stays in the playlist 41 the longest. When a current played video is going to end, the playing module 26 automatically chooses next video from the rest videos in the playlist 41 which stays in the playlist 41 the longest. In other embodiments, the playing module 26 will not play a video automatically. The video which is going to be played can be chosen by a user. When a video is chosen, the playing module 26 plays the chosen video.

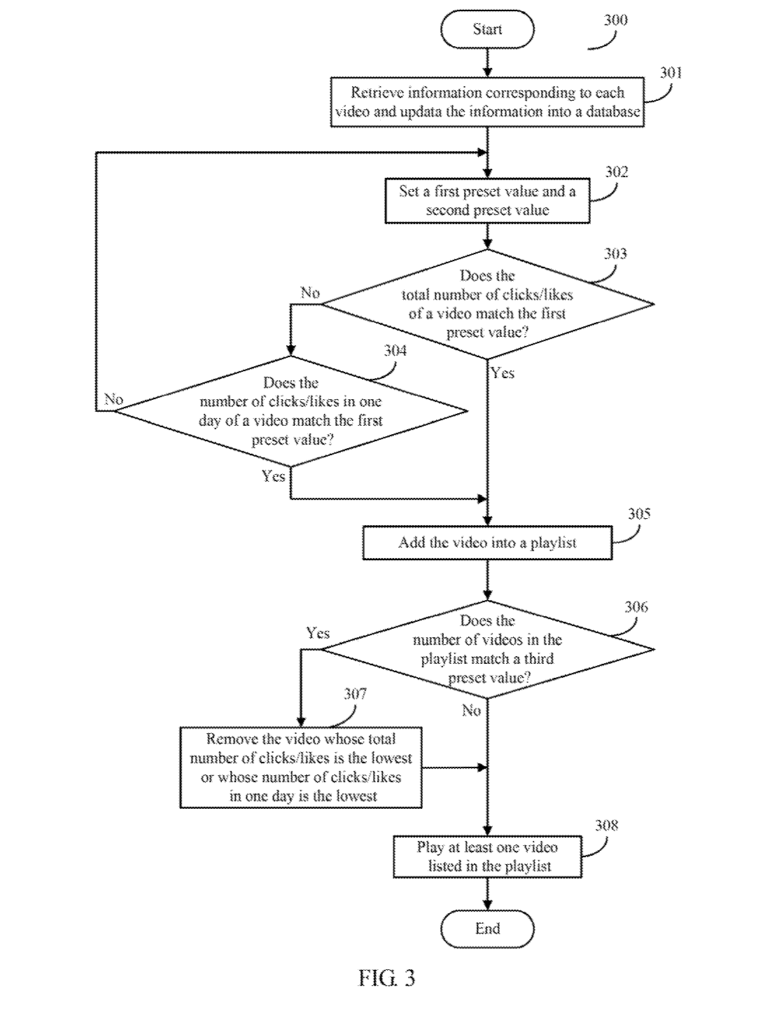

Referring to FIG. 3, a flowchart is presented in accordance with an example embodiment. The example method 300 is provided by way of example, as there are a variety of ways to carry out the method. The example method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Furthermore, the illustrated order of blocks is illustrative only and the order of the blocks can be changed. Additional blocks can be added or fewer blocks may be utilized without departing from this disclosure. The example method 300 can begin at block 301.

At block 301, an updating module retrieves information corresponding to each video stored in the storage device 6 of the server 1, and updates the information into the database 3. In this embodiment, the updating module retrieves information corresponding to each video at a predetermined time interval. The information corresponding to each video includes, but is not limited to, a path where the video is stored in the storage device 6, a total number of clicks, a total number of likes, a number of clicks in one day, a number of likes in one day, an upload time and an upload address of the video.

At block 302, a setting module sets a first preset value and a second preset value. The first preset value is a threshold of the total number of clicks/likes. The second preset value is a threshold of the number of clicks/likes in one day.

In some embodiments, the first preset value and the second can be set to a fix number. For example, the first preset is set to 100000. In some other embodiment, the first preset value and the second preset value can be set dynamically. For example, the setting module makes the videos stored in the storage device 6 in a sequence according to the total number of clicks/likes, and sets the first preset value as the total number of clicks/likes of the nth video, such as n=20.

At block 303, a determination module determines whether the total number of clicks/likes of a video matches the first preset value. If the total number of clicks/likes of a video does not match the first preset value, block 304 is executed. If the total number of clicks/likes of the a video matches the first preset value, block 305 is executed.

When the total number of clicks/likes does not match the first preset value, at block 304, the determination module determines whether the number of the clicks/likes in one day of the video matches the second preset value. If the number of clicks/likes in one day of the video matches the second preset value, block 305 is executed. If the number of clicks/likes in one day of the video does not match the second preset value, block 302 is executed.

At block 305, an adding module adds the video into the playlist 41 whose total number of clicks/likes of the video matches a first preset value or whose number of clicks/likes of the video in one day matches a second preset value. In some embodiments, the adding module also can sequence the videos in the playlist 41 according to the upload time of the video. For example, the video whose upload time is the latest will be on the top/bottom of the playlist 41. In some other embodiments, the adding module sequences the videos in the playlist 41 according to other properties, such as the total number of clicks/likes.

At block 306, the determination module determines whether the total number of videos in the playlist 41 matches a third preset value. If the number of videos in the playlist 41 matches the third preset value, block 307 is executed. If the number of videos in the playlist 41 does not match the third preset value, block 308 is executed.

At block 307, a removing module removes the video from the playlist whose total number of clicks/likes is the lowest or whose number of clicks/likes in one day is the lowest, block 308 is executed.

At block 308, a playing module plays at least one video listed in the playlist 41. The server 1 can be connected by a client (such as a browser) through the Internet. The client can receive the playing interface 4. In some embodiments, the playing module automatically chooses a video from the playlist 41, and plays the chosen video in the playing window 40 of the playing interface 4. For example, the playing module automatically chooses a video from the playlist 41 which stays in the playlist 41 the longest. When a current played video is going to end, the playing module automatically chooses next video from the rest videos in the playlist 41 which stays in the playlist 41 the longest. In other embodiments, the playing module will not play a videos automatically. The video which is going to be played can be chosen by a user. When a video is chosen, the playing module plays the chosen video.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An online video playing method executable by at least one processor of a server, the server comprising a storage device, the storage device storing videos and a database, the database storing information of the videos, the method comprising:
retrieving the information corresponding to each video;
adding the video into a playlist according to the corresponding information; and
playing at least one video listed in the playlist.

2. The method according to claim 1, wherein the information corresponding to each video comprises: a storage path, a total number of clicks, a total number of likes, a number of clicks in one day, a number of likes in one day, an upload time and an upload address of the video.

3. The method according to claim 2, wherein adding the video into a playlist according to corresponding information comprises:
adding the video into the playlist whose total number of clicks/likes of the video matches a first preset value or whose number of clicks/likes of the video in one day matches a second preset value.

4. The method according to claim 3, further comprising:
removing the video from the playlist whose total number of clicks/likes of the video is the lowest or whose number of clicks/likes in one day of the video is the lowest when the number of videos in the playlist matches a third preset value.

5. The method according to claim 1, wherein the at least one video listed in the playlist is played by:
choosing a video which stays in the playlist the longest, from the playlist, and automatically playing the chosen video.

6. A server comprising:
at least one processor, and
a storage device that stores videos, a database stored information of the videos and one or more programs which, when executed by the at least one processor, causes the at least one processor to:
retrieve the information corresponding to each video;
add the video into a playlist according to the corresponding information; and
play at least one video listed in the playlist.

7. The server according to claim 6, wherein the information corresponding to each video comprises: a storage path, a total number of clicks, a total number of likes, a number of clicks in one day, a number of likes in one day, an upload time and an upload address of the video.

8. The server according to claim 7, wherein adding the video into a playlist according to corresponding information comprises:
adding the video into the playlist whose total number of clicks/likes of the video matches a first preset value or whose number of clicks/likes of the video in one day matches a second preset value.

9. The server according to claim 8, wherein the at least one processor further:
removes the video from the playlist whose total number of clicks/likes of the video is the lowest or whose number of clicks/likes in one day of the video is the lowest when the number of videos in the playlist matches a third preset value.

10. The server according to claim 6, wherein the at least one video listed in the playlist is played by:
choosing a video which stays in the playlist the longest, from the playlist, and automatically playing the chosen video.

11. A non-transitory storage medium having shored thereon instruction that, when executed by at least one processor of a server, causes the at least one processor to perform an online video playing method, the method comprising:
retrieving the information corresponding to each video;
adding the video into a playlist according to the corresponding information; and
playing at least one video listed in the playlist.

12. The non-transitory storage medium according to claim 11, wherein the information corresponding to each video comprises: a storage path, a total number of clicks, a total number of likes, a number of clicks in one day, a number of likes in one day, an upload time and an upload address of the video.

13. The non-transitory storage medium according to claim 12, wherein adding the video into a playlist according to the information of the video comprises:
adding the video into the playlist whose total number of clicks/likes of the video matches a first preset value or whose number of clicks/likes of the video in one day matches a second preset value.

14. The non-transitory storage medium according to claim 13, wherein the method further comprising:
removing the video from the playlist whose total number of clicks/likes of the video is the lowest or whose number of clicks/likes in one day of the video is the lowest when the number of videos in the playlist matches a third preset value.

15. The non-transitory storage medium according to claim 11, wherein the at least one video listed in the playlist is played by:
choosing a video which stays in the playlist the longest, from the playlist, and automatically playing the chosen video.
